(19) United States
(12) Patent Application Publication
(10) Pub. No.: US 2007/0097323 A1
(43) Pub. Date: May 3, 2007

(54) Electro-optical wobulator

(76) Inventors: Charles Otis, Corvallis, OR (US); John Bamber, Corvallis, OR (US); Richard J. Oram, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,191

(22) Filed: Oct. 31, 2005

(51) Int. Cl. G02F 1/07; G03B 21/00

(52) U.S. Cl. 353/46; 359/253; 353/122

(57) ABSTRACT

An electro-optical wobulator includes an electro- or magneto- optically active thin film, disposed in an image projection path, and means for selectively applying an electric or magnetic field to the thin film. The thin film has an index of refraction that changes in response to the electric or magnetic field, thereby selectively shifting the projection path of the image.

### BACKGROUND

In the field of image projection systems, it has been found that the resolution of a video image can be increased by temporally subdividing each image frame into multiple image sub-frames, and shifting each sub-frame slightly (e.g. half the width of a pixel) with respect to the other(s) to blur the edges of pixels in the final image frame. This shifting can be with respect to one or two axes, and can go in any direction from a base or standard image projection position. Shifting of the image in this way allows higher resolution without increasing the pixel density in the projection system, and thus without significant cost increase.

In one type of projection system having this sort of image shifting capability, the image shifting is done with a mechanical wobulation device or wobulator. A mechanical wobulation device is essentially a plate, such as a transparent plate (e.g. of glass) or a reflective plate (i.e. a mirror), to which or through which the image is projected. The wobulator plate continuously oscillates or tilts back and forth at some multiple of the base refresh rate of the projection system. This tilting causes a corresponding shift in the projection path of each image sub-frame, either by refraction or reflection, such that adjacent pixel edges in the final image frame appear to overlap and thus provide a higher resolution image.

Oscillation of a mechanical wobulation device can be provided by motors, coils, transducers, etc. Unfortunately, the construction of the transducers that tip the mirror or plate can require sophisticated (and expensive) MEMS and silicon microfabrication techniques. The mechanical device is also subject to stiction, wear, and other mechanical failure mechanisms.

It is also desirable to have accurate control of the operation of a wobulator, so that the degree of image shifting can be accurately controlled. Unfortunately, mechanical wobulators are generally less accurate and more difficult to control than electronic systems. With mechanical wobulators, the desired level of control and accuracy is affected by the precision of placement of components within a projection system. However, ensuring extremely high accuracy in placement of internal projector components can introduce additional cost and complexity to the system. Furthermore, mechanical systems are inherently slower than electronic systems.

### BRIEF DESCRIPTION OF THE DRAWINGS

Various features and advantages of the invention will be apparent from the detailed description which follows, taken in conjunction with the accompanying drawings, which together illustrate, by way of example, features of the invention, and wherein:

FIG. 1 is a plan view of a wobulator plate including a wobulator window;

FIG. 2 is a schematic illustration of a group of pixels shifted by a wobulation system;

FIG. 3 is a cross-sectional view of a reflective electro-optical wobulator having a wedge shaped thin film;

FIG. 4 is a cross-sectional view of a reflective electro-optical wobulator having a non-wedge shaped thin film;

FIG. 5 is a cross-sectional view of a transmissive electro-optical wobulator having a wedge shaped thin film;

FIG. 6 is a cross-sectional view of a transmissive electro-optical wobulator having a non-wedge shaped thin film;

FIG. 7 is a close-up ray trace diagram for both reflective and transmissive electro-optical wobulators having a wedge shaped thin film;

FIG. 8 is a close-up ray trace diagram for both reflective and transmissive electro-optical wobulators having a non-wedge shaped thin film;

FIG. 9 is a schematic diagram of a projection system having a reflective electro-optical wobulator device;

FIG. 10 is a schematic diagram of a projection system having a transmissive electro-optical wobulator device;

FIG. 11 is a diagram of a projection system having two reflective electro-optical wobulator devices disposed in series and having orthogonal polarization directions; and

FIG. 12 is a diagram of a projection system having two transmissive electro-optical wobulator devices disposed in series and having orthogonal polarization directions.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

In the field of video projection, higher resolution images are generally more desirable than lower resolution pictures. However, given spatial constraints and the expense of the apparatus involved, providing higher pixel density in a projection system is relatively costly. Mechanical wobulation systems have been developed as a way to provide the appearance of higher resolution images without having to increase the actual pixel density in the projection system, and thus without such a large cost increase. As used herein, the term “wobulator” refers to any device that shifts the path of a projected image, so that pixel edges in sub-frames of the image overlap and blur together, giving the appearance of a higher resolution image. The term “wobulation” refers to the effect or use of a wobulator.

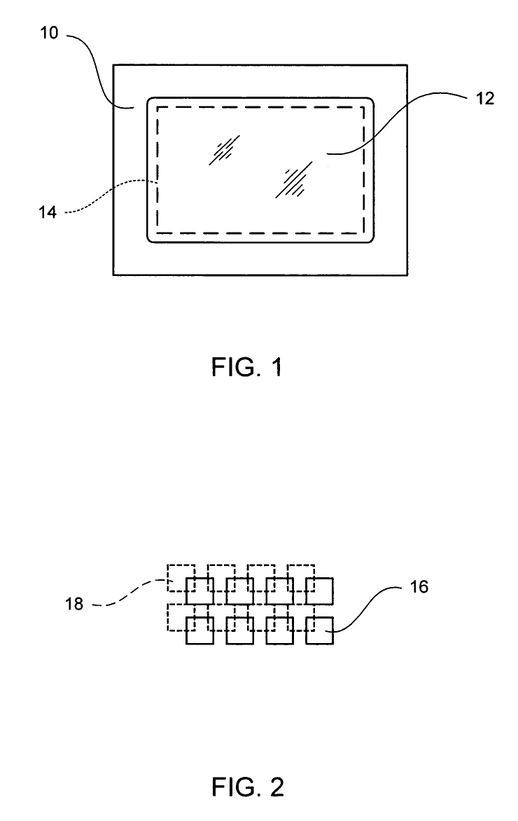

A plan view of one embodiment of a wobulator is shown in FIG. 1. The wobulator generally includes a wobulator plate 10, having a wobulator window, designated generally at 12, disposed therein. The wobulator window can be transmissive or reflective, and can vary in size and shape, depending upon the configuration and characteristics of the other components and its location in the projection system. In mechanical wobulator systems, rectangular wobulator windows of about 35 mm×40 mm have been used, as have circular wobulator windows of about 25 mm in diameter.

For use, as described in more detail hereinafter, the wobulator plate 10 is positioned so that the wobulator window 12 is in the path of a projected image beam (not shown in FIG. 1), the image beam striking or passing through an image region 14 (designated in dashed lines) of the wobulator window. The driving circuitry of the wobulation system (not shown) temporally subdivides each image frame period into multiple image sub-frames, and the wobulator shifts the image path for each image sub-frame. This shifting can be with respect to one or two axes, and can go either direction from a neutral or standard image projection position. By shifting each projected image sub-frame slightly (e.g. some fraction of the dimension of a pixel) with respect to other sub-frames, and sequentially projecting the subframes in rapid succession, the edges of adjacent pixels become blurred together in the final image frame, giving the appearance of a higher resolution image without the need for higher pixel density in the projection system.

The effect of a wobulation system upon an image beam is illustrated in FIG. 2. This figure shows a group of pixels to illustrate the effect of shifting the image as described above. The group of pixels 16, shown in solid lines, represent a portion of an image when at a default projection location. This is the pixel location when the wobulator device is inactive and having no effect. However, when the wobulator device shifts the projection path of the image, the position of the group of pixels is shifted to a shifted pixel position 18, represented in dashed lines.

To produce this effect, the wobulator shifts the image at a rate that is a multiple of the standard image refresh rate, depending upon the number of image sub-frames. For example, if the standard image refresh rate is 60 Hz, and the wobulation device is configured to provide two image positions, the wobulator device must operate at a frequency of 120 Hz to shift each of two sub-frames to its proper position. If there are a greater number of sub-frames, the wobulator is configured to shift to multiple positions at a higher rate. A mechanical wobulation device continuously mechanically tilts the wobulator plate back and forth at this rate, to cause the path of the image beam to shift via reflection or refraction due to the optical characteristics of the wobulator window.

Unfortunately, there are limits to the speed of mechanical wobulators, and they are subject to wear, mechanical failure, and their tilt can be difficult to control. Additionally, with mechanical wobulators the precision of placement of components is very important, adding cost and complexity, and their construction can require sophisticated and expensive microfabrication techniques.

The inventors have developed an electro-optical wobulator system that performs the wobulation function entirely electronically, with no moving parts. Like the wobulator depicted in FIG. 1, an electro-optical wobulator device generally includes a wobulator plate 10, having a wobulator window 12 disposed therein. The wobulator window can vary in size and shape, and wobulator windows of a similar size and shape to those used mechanical wobulator systems can be used for an electro-optical wobulator. The wobulator device is positioned so that the wobulator window is in the path of a projected image beam, the image beam striking the image region 14 of the wobulator window. As used herein, the term “wobulator window” is intended to encompass substantially transparent windows through which the image beam passes, and reflective wobulator windows, which include a mirror or other reflective surface to reflect the image beam.

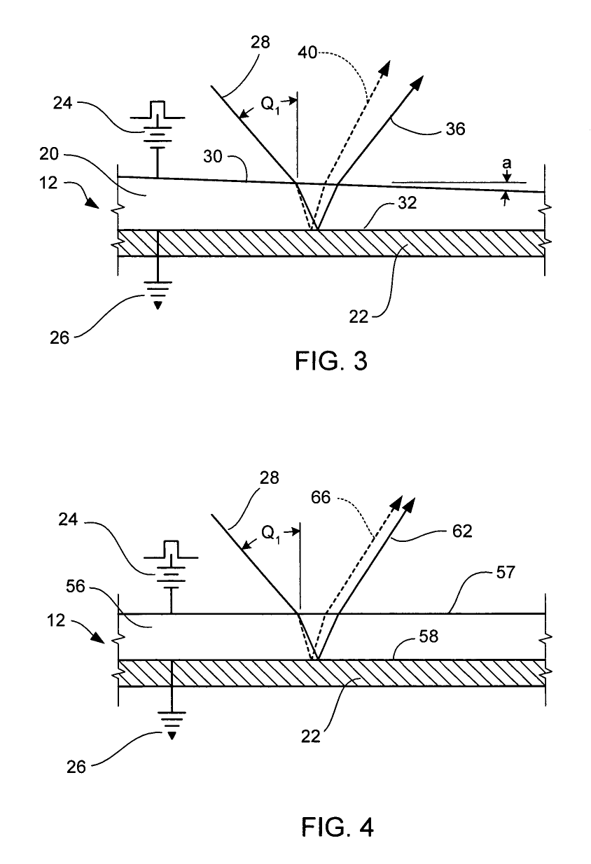

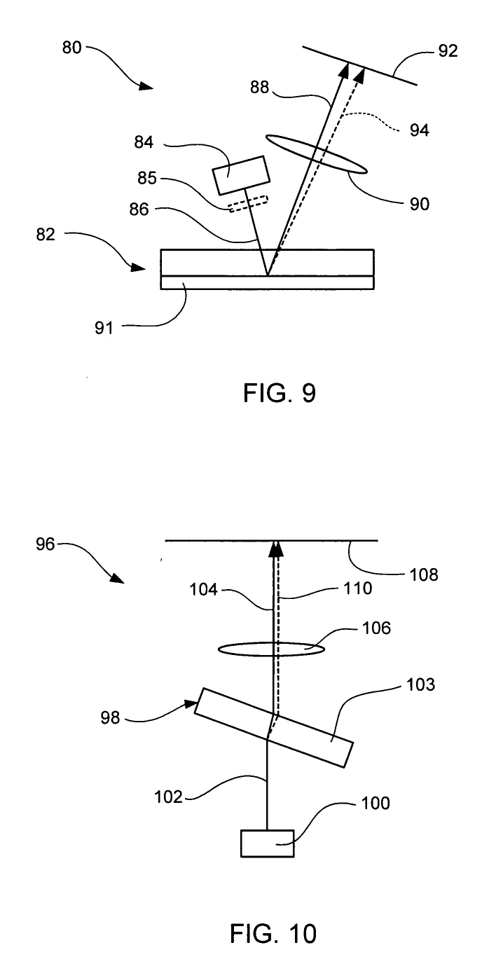

Embodiments of electro-optical wobulator systems shown herein include reflective and transmissive wobulator windows. Both reflective and transmissive electro-optical wobulators can use either a wedge shaped thin film or a non-wedge shaped thin film. One embodiment of a reflective electro-optical wobulator having a wedge shaped thin film is shown in cross-section in FIG. 3, and a projection system incorporating the same is depicted in FIG. 9. It will be apparent that the wobulator windows in the views of FIGS. 3-12 are greatly simplified and exaggerated in size and thickness for illustrative purposes.

Viewing FIG. 3, the wobulator window 12 includes a wedge shaped thin film of material 20 that is deposited on a mirror substrate 22, and has a wedge angle a. The thin film is transparent to visible light (e.g. from about 400 nm to about 700 nm wavelength), and is electro- or magneto-optically active. Consequently, an electric or magnetic field applied across the film will change its index of refraction. In this embodiment, a voltage source 24 and ground connection 26 are attached to opposing faces of the thin film, and provide an electric field across the thin film to create a change in the index of refraction of the thin film material 20. The electric field can be applied to the thin film using transparent electrodes (not shown), such as are commonly used in liquid crystal displays. While FIGS. 3-6 show an electrical potential across the thin film, and the discussion herein specifically refers to an e-field and an electro-optically active thin film, it will be apparent that the principles involved apply equally to magneto-optically active thin films. Those skilled in the art will recognize that where the thin film is magneto-optically active, providing a magnetic field across the thin film can also function to change the index of refraction in a similar manner.

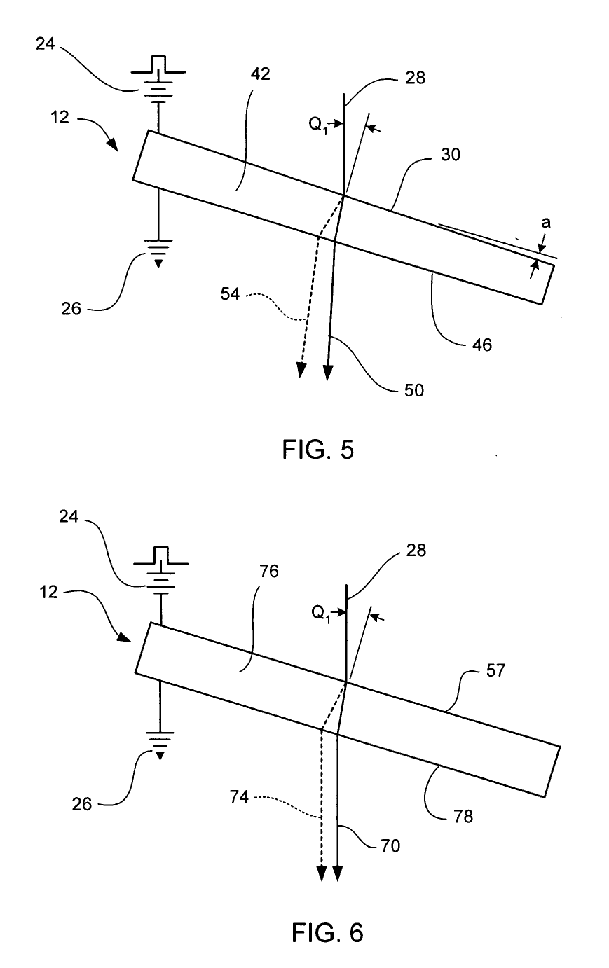

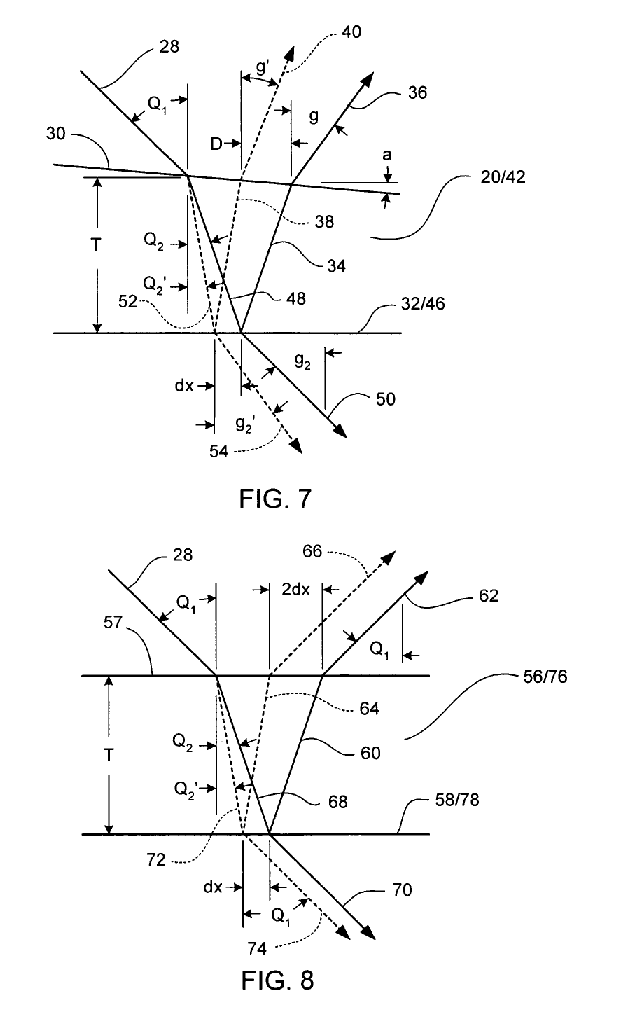

Provided in FIG. 7 is a ray trace showing the relationship between the angle of incidence Q₁ of an image beam 28, and its exit angle g or g′, depending upon the index of refraction of the thin film 20. It should be recognized that FIG. 7 provides ray traces for the wedge shaped thin film for both the reflective wobulator configuration, shown in FIG. 3, and the transmissive wobulator configuration, shown in FIG. 5 and described below. Consequently, the wedge shaped thin film in FIG. 7 is designated with numerals 20 and 42 to correspond to the designation of the structures in FIGS. 3 and 5, respectively. Similarly, reference numeral 32 refers to the reflective surface in FIG. 3, while numeral 46 refers to the bottom surface of the thin film in FIG. 5. Both of these numerals are used in FIG. 7 to point to the corresponding structure.

In order to have a refractive effect, the angle of incidence Q₁ of image beam 28 must be some angle that is not perpendicular to the top surface 30 of the thin film. When no electrical potential is applied to the thin film, upon contact with the top surface of the thin film, the image beam is initially refracted to a refracted beam 48 that is at some angle Q₂ due to the index of refraction n₂ of the thin film. The refracted beam reflects off of the reflective surface 32 at the same angle (Q₂), and the reflected beam 34 passes through the upper surface of the thin film a second time.

The wedge angle a of the top surface 30 of the thin film 20 is some value greater than zero. The inventors contemplate that angles of from about 1° to about 15° are likely to be used. Larger wedge angles can also be used, but as the wedge angle increases, the thickness of the film also increases. Because the top surface of the thin film is sloped at the wedge angle a, the angle of incidence of the reflected image beam 34 relative to the top surface when the image beam passes through the second time is not the same as the first angle of incidence. Consequently, the angle g of the exit beam 36 is not the same as the entrance angle Q₁. The angle g of the exit beam is given by the following equation:
g=sin⁻¹{(n₂/n₁)sin(2a−sin⁻¹[(n₁/n₂)sin Q₁])} (1)
where n₁ is the index of refraction of air, n₂ is the index of refraction of the thin film, a is the wedge angle of the top surface 30 of the thin film, and Q₁ is the angle of incidence of the image beam 28 (measured relative to the vertical).

When an electric field is applied to the thin film 20, the index of refraction n₂ of the thin film changes. Consequently, when the image beam 28 passes through the top surface 30 of the thin film, the image beam is refracted a different amount to shifted refracted beam path 52 at angle Q₂′, reflects off of the reflective surface 32 at this angle, and the shifted reflected beam 38 passes through the upper surface of the thin film a second time. With the opposing surfaces of the thin film non-parallel, the change in index of refraction caused by the electric field causes the shifted exit beam 40 to deviate from exit angle g to exit angle g′ as a result of this second refraction. The magnitude of the change in exit angle is given by equation (1) above, with the changed value of n₂ substituted in. The change in the index of refraction n₂ upon the application of an electric field across the thin film is given by the following equation:
Δn₂=½(R) (n₂³)(E) (2)
where R is the electro-optic coefficient of the thin film material (meters/volt), n₂ is the index of refraction of the thin film material, and E is the intensity of the electric field (volts/meter).

In addition to the angular shift caused by the wedge angle of the thin film, the image beam will also experience a lateral shift that is a function of the thickness T of the thin film. The magnitude of this change is given by the following equation:
dx=T{tan [sin⁻¹(n₁/n₂ sin Q₁)]−tan[sin⁻¹((n₁ sin Q₁)/(n₂+Δn₂))]} (3)
where T is the thickness of the thin film, n₁ is the index of refraction of air, n₂ is the index of refraction of the thin film, Q₁ is the angle of incidence of the image beam (measured relative to the vertical), and Δn₂ is the change in the index of refraction n₂ upon the application of the electric field. The value of Δn₂ is given by equation (2) above. As noted above, when the thin film 20 is activated, upon passing through the top surface 30 of the thin film the angle of the image beam 28 is changed from angle Q₂ to Q₂′. Accordingly, the location of reflection of the beam upon the reflective surface 32 shifts by a distance dx, according to equation (3) and as shown in FIG. 7. Accordingly, after reflection, the location at which the beam exits through the top surface shifts a distance D from the exit position of the initial exit beam 36 to the shifted exit position of shifted exit beam 40. The value of D is slightly less than 2dx due to the wedge angle.

Because the lateral shift of the exit beam is a function of the thickness T of the thin film, according to equation (3), and the wedge shaped thin film varies in thickness, it will be apparent that the magnitude of the lateral beam shift dx will vary as the thickness of the thin film varies. However, the angular shift does not depend upon the thickness of the thin film. Accordingly, this linearly varying lateral shift can be accommodated with the use of optical devices to compensate for the linear change in positional shift.

The magnitude of shifting provided by a wobulation device can be very small. Wobulation devices are generally configured to provide a shift that is less than the maximum dimension of a pixel, and can be about ¼ of a pixel. The amount of image beam displacement required to shift an image +/−0.25 pixels is about +/−5 microns. Accordingly, the actual angular and lateral shift provided by a change in refraction of the thin film is correspondingly small.

A suitable material for use as a thin film in this device is transparent to visible light (e.g. from about 400 nm to about 700 nm wavelength), and has an electro-optic (or magneto-optic) coefficient that is sufficiently high to effect a several micron shift (e.g. greater than about 2 microns) in the pixel position. At least two such materials have been identified. One suitable material is a barium-strontium-niobium-oxide material (BaSrNb₂O₆). This material has an electro-optic coefficient R of 1340×10⁻⁶ m/V. Another suitable material is Barium Titanate (BaTiO₃), which has an electro-optic coefficient R of 1640×10⁻¹² m/V.

Advantageously, the index of refraction of the thin film can be changed on an extremely short time scale (relative to the frame rate of a projection device). This allows very fast shifting of the image position. Additionally, since the magnitude of change of the index of refraction is a function of the intensity of the electric field, the magnitude of change in the exit angle of the image beam can be varied by controlling the voltage applied across the thin film. Consequently, by varying the voltage between more than two levels, the system can shift the image beam between more than two positions.

A transmissive electro-optical wobulator can also be provided using a wedge-shaped thin film. An embodiment of such a wobulator device is shown in FIG. 5, and a diagram of a projection system using the same is shown in FIG. 10. In the embodiment of FIG. 5, rather than having the thin film disposed on a mirror or other reflective substrate, the transmissive wobulator window can comprise the thin film 42 alone, or the thin film can be disposed upon glass or other suitable transparent material, and allows the image beam to pass through the material. FIG. 7 provides a ray trace of the effects of this embodiment on the exit angle of the image beam.

Viewing FIGS. 5 and 7 together, the image beam 28 contacts the top surface 30 of the thin film 42 at an entrance angle Q₁. The image beam is first refracted to refracted path 68 at angle Q₂, and then immediately passes through the lower surface 46 of the thin film, rather than reflecting off of a reflective surface. Because the top surface of the thin film is sloped at the wedge angle a relative to the bottom surface, the angle of incidence of the refracted image beam relative to the bottom surface is different than the entrance angle Q₁ relative to the top surface. Consequently, the angle g₂ of the exit beam 50 will differ from the entrance angle.

When the electric field is applied to the thin film 42, the index of refraction of thin film 42 is changed. This shifts the beam first to shifted refracted path 52, and causes the exit beam 54 to deviate from exit angle g₂ to g₂′. Because the image beam passes through the top surface of the thin film only once in the transmissive case, the angular shift will be half the magnitude as that in the reflective case. In other words, the angular difference between angles g₂ and g₂′ will be half the difference between angles g and g′. Thus the magnitude of the change in exit angle is equal to half the value given by equation (1), with the changed value of n₂ substituted in. Similarly, the exit position of the exit beam is laterally shifted by the distance dx, given by equation (3) above, from the position of the original exit beam 50 to that of the shifted exit beam 54.

An electro-optical wobulator can also be configured with a non-wedge shaped thin film—that is, a thin film having top and bottom surfaces that are parallel to each other. One embodiment of a reflective electro-optical wobulator having a constant thickness thin film is provided in FIG. 4, and a corresponding ray trace is provided in FIG. 8. As with FIG. 7, the ray trace in FIG. 8 applies to the constant thickness thin film for both the reflective wobulator configuration, shown in FIG. 4, and the transmissive wobulator configuration, shown in FIG. 6. Consequently, the thin film in FIG. 8 is designated with numerals 56 and 76 to correspond to the designations in FIGS. 4 and 6, respectively and reference numerals 58 and 78 are both used in FIG. 8 to correspond to the reflective surface in FIG. 4 and the bottom surface of the thin film in FIG. 6, respectively.

In this configuration, the image beam 28 initially contacts the wobulator at an entrance angle Q₁. Upon contact with the top surface 57 of the thin film 56, the entering image beam is initially refracted to refracted path 68 at angle Q₂ due to the index of refraction of the thin film. The image beam reflects off of the reflective surface 58 at this angle, and the reflected beam 60 passes through the upper surface of the thin film a second time. Because the two surfaces of the thin film are parallel, there is no angular change in the path of the image beam. The angle of the exit beam 62 is always equal to the angle of incidence Q₁ for any value of the index of refraction. Thus, a change in the index of refraction will have no effect on that angle, causing the shifted exit beam 66 to be parallel to exit beam 62.

However, a change in the index of refraction of the thin film 56 will cause a linear change in the position of the shifted exit beam 66, in accordance with equation (3) above. Since the thickness T of the thin film is constant, the position shift of the exit beam 66 relative to the unshifted position is equal to 2dx for the reflective electro-optical wobulator depicted in FIG. 4. Thus the unshifted exit beam 62 and the shifted exit beam are parallel, but separated by a distance of 2dx.

The transmissive case with a constant thickness thin film 76 is shown in FIGS. 6 and 8. In this configuration the image beam 28 strikes the wobulator window 12 at an entrance angle Q₁, and is refracted to a refracted beam path 68 at angle Q₂, and then passes through the lower surface 78 of the thin film. Again, because the two surfaces of the thin film are parallel, the exit beam 70 is parallel to the entrance beam 28. However, when an electric field is applied to the thin film, the index of refraction of the thin film changes, causing the refracted beam to follow shifted path 72, producing a linear change dx in the position of the shifted exit beam 74 according to equation (3). Thus the unshifted exit beam and the shifted exit beam are parallel, but separated by the distance dx.

The magnitude of the positional shift of the exit beam with a change in index of refraction depends upon the factors noted in equation (3), including geometry and the particular thin film material used. For the case of Barium Titanate, a charge of 4000 volts applied across a 2 mm thick film (constant thickness) will change the index of refraction by 2.5×10⁻². This change in index will produce a 6 micron shift in the position of the exit ray for a reflective wobulator configuration like that shown in FIGS. 4 and 8 (i.e. 2dx=6 microns). For comparison, this shift is approximately half the size of a pixel of a typical digital light processor (DLP).

Shown in FIGS. 9 and 10 are schematic diagrams of projection systems incorporating an electro-optical wobulator. Shown in FIG. 9 is one embodiment of a projection system 80 having a reflective electro-optical wobulator 82. This system includes a spatial light modulator 84, which projects an image beam 86 toward the wobulator window. The spatial light modulator can be any of a variety of devices, such as digital mirror devices (DMD), liquid crystal digital (LCD) projectors, etc. When the electro-optical wobulator device is not activated, the exit beam 88 passes through projection optics 90 after reflection from the wobulator mirror 91, and thence to a screen or other projection surface 92.

However, when the electro-optical wobulator 82 is activated, the index of refraction of the thin film changes, and the shifted exit beam 94 (represented in dashed lines) is angularly displaced by a small amount in one direction. While the system depicted in FIG. 9 is shown as creating an angular shift in the exit beam, this is for illustrative purposes only. A reflective electro-optical wobulator that provides only a lateral beam displacement, as shown and described with respect to FIG. 4, can also be provided in a projection system like that shown in FIG. 9.

Shown in FIG. 10 is a schematic diagram of a projection system 96 having a transmissive electro-optical wobulation device 98. Like the reflective system shown in FIG. 9, the transmissive system includes a spatial light modulator 100, which projects an image beam toward the wobulator window 103. The image beam passes through the wobulator window, and the exit beam 104 then passes through projection optics 106, and thence to a projection surface 108 (e.g. a screen).

When the thin film 103 is not activated, the path of the exit beam 104 is undisturbed, so that the initial and final projection paths are substantially parallel, unless altered by any effects of the projection optics 106. However, when the thin film is activated, the path of the exit beam is affected by the change in refractive properties of the window, and is shifted, thus providing a shifted exit beam 110 (indicated by dashed lines). While the system depicted in FIG. 10 is shown as creating a lateral shift, not an angular shift, in the exit beam, this is for illustrative purposes only. A transmissive electro-optical wobulator that also provides an angular beam displacement, as shown and described with respect to FIG. 6, for example, can also be provided in a projection system like that shown in FIG. 10.

The various embodiments of the electro-optical wobulator system disclosed herein use polarized light. When the electric or magnetic field is applied to the thin film, the index of refraction of the thin film changes only with respect to one axis, depending upon the direction of the electric or magnetic field. With respect to the other crystalline axes there is no change. Consequently, a non-polarized light source would cause a blur in each pixel as the component of the beam that was at orthogonal polarization to the diverted beam would remain undiverted and would appear as a smeared pixel. To avoid blurring of pixels, the light is polarized in a direction parallel to the plane of incidence of the beam upon the wobulator, to eliminate the component of the beam that is at orthogonal polarization to the direction of the electric or magnetic field (which is the axis of wobulation). Because lasers are naturally well polarized in one direction, a projector having laser light sources is well suited to this device. However, polarization optics can also be used to allow the use of other types of light sources. Such a configuration is shown in FIG. 9, where a polarizing device 85 is disposed adjacent to the spatial light modulator 84. This type of configuration is applicable to all of the projection system configurations disclosed herein.

Compensation for dispersion (wavelength dependence of the index of refraction) can be accomplished with a small variation in drive voltage (for an electro-optically active thin film) or the magnetic field intensity (for a magneto-optically active thin film) as the source color (e.g. from a laser) is changed between the primary projection colors (e.g. from red to green to blue). That is, different values of dispersion (dn/dl) in the film would tend to move the pixel laterally or vertically for each projection color depending upon the wavelength of the color. However, this can be easily handled by sequentially applying different drive voltages/magnetic fields for each projection color.

As noted above, an electro-optical wobulator can shift an image between multiple positions through varying the voltage of the electric field. Where a single electro-optical wobulator is employed, each of these multiple positions will lie along a single axis because of the polarization effects discussed above. Nevertheless, the direction of shifting along a single axis can be selected to provide the appearance of shifting along multiple axes. For example, the shifted pixel group 18 shown in FIG. 2 is shifted upward and to the left of the default pixel location 16. This sort of shift can be produced by a single wobulator device that is oriented so as to shift the image along an axis oriented at an angle (e.g. 45°) with respect to the alignment of rows and columns of pixels in the image.

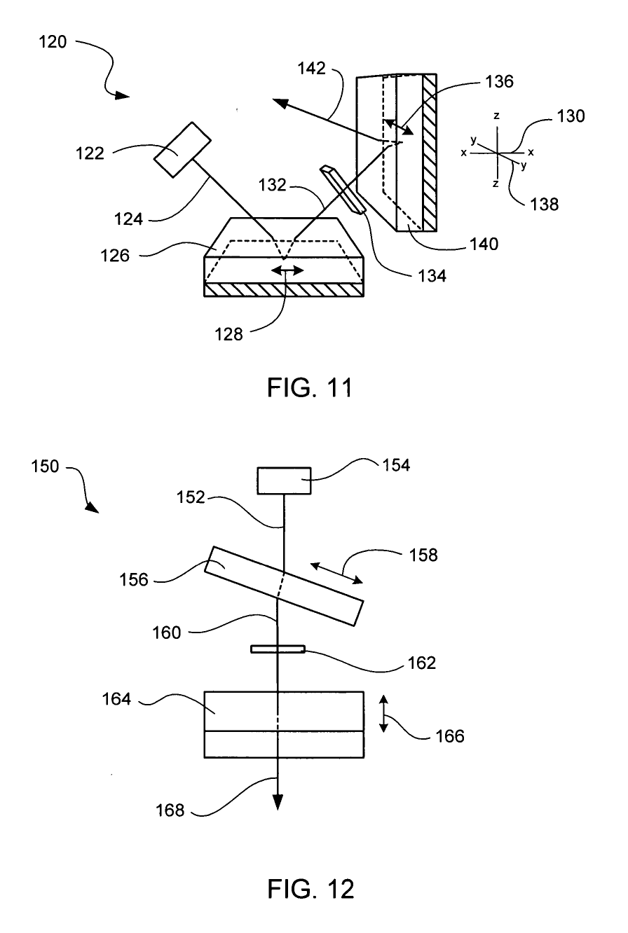

However, an electro-optical wobulator system that shifts the image beam with respect to more than one axis can also be provided. This generally requires providing two wobulators in series, each one configured to shift the image beam along an axis that is at an angle (e.g. orthogonal) to that of the other. Shown in FIG. 11 is a perspective view of one embodiment of a two axis reflective electro-optical wobulator system 120. In this system, the spatial light modulator 122 projects an image beam 124, which reflects from a first reflective wobulator 126 that is configured to shift the image beam, in the manner described above, in the direction of arrow 128, which corresponds to the x-axis 130 in this view. The light of the image beam is initially polarized to correspond to this direction. After this first shift, a first reflected image beam 132 passes through a half wave plate 134, which rotates the direction of polarization of the light by 90° to be parallel to the direction of arrow 136, which corresponds to the y-axis 138 in this view.

The first reflected image beam 132 then reflects from a second reflective wobulator 140 that is oriented at 90° to the first wobulator 126, and which is configured to provide a shift of the image beam in the direction of arrow 136. In this way, the final exit beam 142 can be shifted among multiple positions or paths in the x-y plane.

Provided in FIG. 12 is a top view of a multi-axis transmissive electro-optical wobulator system 150. An image beam 152 from a spatial light modulator 154 passes through a first transmissive wobulator window 156 and is shifted in the direction of arrow 158. The first exit beam 160 then passes through a half wave plate 162, which rotates the direction of polarization of the light by 90°, and then passes through a second transmissive wobulator 164 that is configured to provide a shift of the image beam in the direction of arrow 166, which is perpendicular to arrow 158. In this way, the final exit beam 168 can be shifted among multiple positions or paths in a plane. It will be apparent that the illustrations of FIGS. 11 and 12 are schematic in nature, and that an actual device may look much different.

The electro-optical wobulator is advantageous because there are no moving parts to wear out or to experience stiction. Its fabrication is much simpler than a moving electro-mechanical device, and it is capable of operation at speeds in the hundreds of MHz range, far in excess of electro-mechanical devices that require precision, repeatable motion.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. An electro-optical wobulator system, comprising:
an image beam of polarized light, projected along a projection path; and
a first wobulator window, comprising a thin film, disposed in the projection path at a first angle that is non-perpendicular and non-parallel to the projection path, the thin film having an index of refraction that is selectively changeable in response to one of an electric and a magnetic field applied thereto, the one of the electric and magnetic field selectively shifting the projection path in a first plane.

2. An electro-optical wobulator system in accordance with claim 1, wherein the wobulator window further comprises a reflective substrate, underlying the thin film, the image beam passing through the thin film window in a first direction, reflecting off the reflective substrate, and exiting the thin film in a second direction.

3. An electro-optical wobulator system in accordance with claim 1, wherein the thin film is substantially wedge-shaped, having a top surface at a wedge angle relative to a bottom surface thereof, thereby producing a positional shift and an angular shift in the image beam upon exit from the thin film.

4. An electro-optical wobulator system in accordance with claim 3, wherein the wedge angle is in the range of about 1° to about 15°.

5. An electro-optical wobulator in accordance with claim 1, wherein the thin film has a substantially constant thickness, having a top surface that is substantially parallel to a bottom surface thereof, thereby producing a positional shift in the image beam upon exit from the thin film.

6. An electro-optical wobulator system in accordance with claim 1, wherein the wobulator window is configured to transmit the image beam therethrough, the image beam passing through a first side of the window, and exiting through a second side of the window.

7. An electro-optical wobulator system in accordance with claim 1, further comprising a second wobulator window, comprising a thin film, disposed in the projection path in series with the first wobulator window at a second angle that is non-perpendicular and non-parallel to the projection path and in a plane that is substantially orthogonal to a plane of the first angle, the thin film of the second wobulator window having an index of refraction that is selectively changeable in response to an electric or magnetic field applied thereto, so as to selectively shift the projection path in a second plane that is substantially orthogonal to the first plane.

8. An electro-optical wobulator system in accordance with claim 7, further comprising a half wave plate, disposed between the first and second wobulator windows, configured to rotate the angle of polarization of the image beam by about 90°.

9. An electro-optical wobulator system in accordance with claim 1, wherein the thin film is substantially transparent to visible light, and has an electro/magneto-optic coefficient that is sufficient to effect a shift in the projection path that is greater than about 2 microns.

10. An electro-optical wobulator system in accordance with claim 1, wherein the thin film is selected from the group consisting of barium-strontium-niobium-oxide (BaSrNb₂O₆) and Barium Titanate (BaTiO₃).

11. An electro-optical wobulator, comprising:
a thin film, disposed in a projection path of an image beam, having an index of refraction that is changeable in response to an electric or magnetic field; and
means for selectively applying one of an electric and magnetic field to the thin film, thereby selectively shifting the projection path.

12. An electro-optical wobulator in accordance with claim 11, further comprising a reflective substrate, underlying the thin film, the image beam passing through the thin film window in a first direction, reflecting off the reflective substrate, and exiting the thin film in a second direction.

13. An electro-optical wobulator in accordance with claim 11, wherein the thin film is configured to transmit the image beam therethrough, the image beam passing from a first side of the thin film to a second and opposite side of the thin film.

14. An electro-optical wobulator in accordance with claim 11, wherein the thin film is substantially wedge-shaped, having a top surface at a wedge angle relative to a bottom surface thereof, thereby producing a positional shift and an angular shift in the image beam upon exit from the thin film.

15. An electro-optical wobulator in accordance with claim 11, wherein the thin film has a substantially constant thickness, having a top surface that is substantially parallel to a bottom surface thereof, thereby producing a positional shift in the image beam upon exit from the thin film.

16. An electro-optical wobulator in accordance with claim 11, further comprising means for polarizing the image beam prior to incidence upon the thin film.

17. An electro-optical wobulator in accordance with claim 16, wherein the means for polarizing the image beam is selected from the group consisting of a laser light source associated with spatial light modulator, and a polarizing device disposed adjacent to the spatial light modulator.

18. An electro-optical wobulator in accordance with claim 11, wherein the means for selectively applying an electric field to the thin film comprises a voltage source, configured to apply a voltage between a top surface and bottom surface of the thin film.

19. An electro-optical wobulator in accordance with claim 18, wherein the voltage source is configured to apply the voltage at a plurality of voltage levels, thereby selectively shifting the projection path between a plurality of exit beam paths.

20. An electro-optical wobulator in accordance with claim 11, wherein the thin film is selected from the group consisting of barium-strontium-niobium-oxide (BaSrNb₂O₆) and Barium Titanate (BaTiO₃).

21. A projection system, comprising:
a spatial light modulator, configured to project a polarized image beam along a projection path;
first and second wobulator windows, disposed in the projection path in series, each wobulator window including a thin film having an index of refraction that is selectively changeable in response to an electric or magnetic field, the first wobulator window being configured to selectively shift the projection path relative to a first axis, and the second wobulator window being configured to selectively shift the projection path relative to a second axis that is substantially orthogonal to the first axis.

22. A projection system in accordance with claim 21, wherein the first and second wobulator windows further comprise a reflective substrate, underlying the thin film, the image beam passing through the thin film window in a first direction, reflecting off the reflective substrate, and exiting the thin film in a second direction.

23. A projection system in accordance with claim 21, wherein first and second wobulator windows are each configured to transmit the image beam therethrough, the image beam passing from a first side of the thin film to a second and opposite side of the thin film.

24. A projection system in accordance with claim 21, wherein the thin film of the first and second wobulator windows is substantially wedge-shaped, having a top surface at a wedge angle relative to a bottom surface thereof, thereby producing a positional shift and an angular shift in the image beam upon exit from the thin film.

25. A projection system in accordance with claim 21, wherein the thin film has a substantially constant thickness, having a top surface that is substantially parallel to a bottom surface thereof, thereby producing a positional shift in the image beam upon exit from the thin film.

26. A projection system in accordance with claim 21, further comprising a half wave plate, disposed between the first and second wobulator windows, configured to rotate the angle of polarization of the image beam by about 90°.

27. A method for shifting a projected image, comprising the steps of:
shifting the projection path of a polarized image beam in a first plane through refraction by a thin film of a first wobulator window, the thin film of the first wobulator window having an index of refraction that is selectively changeable in response to one of an electric and a magnetic field applied thereto; and
applying one of an electric and a magnetic field to the thin film of the first wobulator window, so as to change an index of refraction thereof, and thereby change the shifting of the projection path within the first plane.

28. A method in accordance with claim 27, wherein the step of shifting the projection path of the polarized image beam further comprises reflecting the image beam from a reflective surface underlying the electromagnetically active thin film, such that a distance traveled through the thin film by the image beam is approximately doubled.

29. A method in accordance with claim 27, further comprising the steps of:
shifting the projection path of the polarized image beam in a second plane that is substantially orthogonal to the first plane, through refraction by a thin film of a second wobulator window disposed in series with the first wobulator window, the thin film of the second wobulator window having an index of refraction that is selectively changeable in response to one of an electric and a magnetic field applied thereto; and
applying one of an electric and a magnetic field to the thin film of the second wobulator window, so as to change an index of refraction thereof, and thereby change the shifting of the projection path within the second plane.
